(19) United States
(12) Patent Application Publication
(10) Pub. No.: US 2022/0044090 A1
(43) Pub. Date: Feb. 10, 2022

(54) COMPUTING DEVICE USING SPARSITY DATA AND OPERATING METHOD THEREOF

(71) Applicant: KOREA ADVANCED INSTITUTE OF SCIENCE AND TECHNOLOGY, Daejeon (KR)

(72) Inventors: Hoi Jun YOO, Daejeon (KR); Sanghoon KANG, Daejeon (KR)

(73) Assignee: KOREA ADVANCED INSTITUTE OF SCIENCE AND TECHNOLOGY, Daejeon (KR)

(21) Appl. No.: 17/073,839

(22) Filed: Oct. 19, 2020

(30) Foreign Application Priority Data
Aug. 6, 2020 (KR) 10-2020-0098417

(51) Int. Cl. G06N 3/02; G06F 7/483

(52) U.S. Cl. CPC G06N 3/02; G06F 7/483

(57) ABSTRACT

A computing device includes a first computing core that generates sparsity data based on a first sign bit and first exponent bits of first data and a second sign bit and second exponent bits based on second data, and a second computing core that outputs a result value of a floating point calculation of the first data and the second data as output data or skips the floating point calculation and outputs the output data having a given value, based on the sparsity data.

### CROSS-REFERENCE TO RELATED APPLICATIONS

This application claims priority under 35 U.S.C. § 119 to Korean Patent Application No. 10-2020-0098417 filed on Aug. 6, 2020, in the Korean Intellectual Property Office, the disclosures of which are incorporated by reference herein in their entireties.

### BACKGROUND

Embodiments of the inventive concept described herein relate to computing device and an operating method thereof, and more particularly, relate to a computing device using sparsity data and an operating method thereof.

Nowadays, as a technology for image recognition, a convolution neural network (CNN) being one of deep neural network (DNN) techniques is being actively developed. A CNN-based computing device provides an excellent performance in various object recognition fields such as object recognition and script recognition, may accurately recognize an operation of an object, and may be used to generate an accurate fake image in a generative adversarial network (GAN).

However, the CNN-based computing device acquires an accurate computing result but requires a lot of calculations for inference and learning. As the number of calculations to be processed increases, the CNN-based computing device causes the following issues: an increase in a time necessary for calculation, a delay of a processing speed, and an increase in power consumption.

### SUMMARY

Embodiments of the inventive concept provide a computing device omitting unnecessary calculations by using sparsity data generated based on a simplified floating point calculation and an operating method thereof.

A computing device according to an embodiment of the inventive concept includes a first computing core that generates sparsity data based on a first sign bit and first exponent bits of first data and a second sign bit and second exponent bits based on second data, and a second computing core that outputs a result value of a floating point calculation of the first data and the second data as output data or skips the floating point calculation and outputs the output data having a given value, based on the sparsity data.

In an exemplary embodiment, the first data are included in an input layer of a deep neural network or are included in at least one hidden layer of the deep neural network.

In an exemplary embodiment, the floating point calculation is performed based on the first sign bit, the first exponent bits, and first fraction bits of the first data and the second sign bit, the second exponent bits, and second fraction bits of the second data.

In an exemplary embodiment, the computing device further includes a first memory device that stores the first data, a second memory device that stores the second data, and a third memory device that stores the output data.

In an exemplary embodiment, the first computing core calculates at least one sign value based on the first sign bit and the second sign bit, calculates at least one exponent value based on the first exponent bits and the second exponent bits, calculates at least one partial sum based on the at least one sign value and the at least one exponent value, generates the sparsity data having a first value when a value of accumulating the at least one partial sum exceeds a threshold value, and generates the sparsity data having a second value when the value of accumulating the at least one partial sum is equal to or less than the threshold value.

In an exemplary embodiment, the first computing core includes a logic gate that generates a sign operation signal based on an exclusive OR logic operation of the first sign bit and the second sign bit, a first fixed point adder that generates an exponent operation signal based on an addition of the first exponent bits and the second exponent bits, a data linear encoder that generates a partial operation signal based on the sign operation signal and the exponent operation signal, a second fixed point adder that generates an integrated operation signal or an accumulation operation signal, based on a previous accumulation operation signal corresponding to at least one previous partial operation signal and the partial operation signal, a register that provides the previous accumulation operation signal to the second fixed point adder and stores the accumulation operation signal, and a sparsity data generator that generates the sparsity data having a first value when a value corresponding to the integrated operation signal exceeds a threshold value and generates the sparsity data having a second value when the value corresponding to the integrated operation signal is equal to or less than the threshold value.

In an exemplary embodiment, the second computing core includes an out-zero skipping module that determines whether the sparsity data have a first value or a second value, controls whether to perform the floating point calculation, and generates the output data having the given value when it is determined that the sparsity data have the second value, and a floating point multiply-accumulate (FPMAC) unit that performs the floating point calculation under control of the out-zero skipping module and generates the result value of the floating point calculation as the output data.

In an exemplary embodiment, the second computing core further includes an in-zero skipping module that generates the output data having the given value when a value of the first exponent bits or a value of the second exponent bits is equal to or less than a threshold value.

In an exemplary embodiment, the first data are input data expressed by a 16-bit floating point, a 32-bit floating point, or a 64-bit floating point complying with an IEEE (Institute of Electrical and Electronic Engineers) 754 standard, and the second data are weight data expressed by the 16-bit floating point, the 32-bit floating point, or the 64-bit floating point complying with the IEEE 754 standard.

A computing device according to an embodiment of the inventive concept includes a first computing core that generates sparsity data based on first data and second data, and a second computing core that outputs one of a result value of a floating point calculation of the first data and the second data and a given value as output data, based on the sparsity data.

In an exemplary embodiment, the sparsity data are generated based on a sign and an exponent of the first data and a sign and an exponent of the second data, and the floating point calculation is performed based on the sign, the exponent, and a fraction of the first data and the sign, the exponent bits, and a fraction of the second data.

In an exemplary embodiment, the second computing core determines whether the sparsity data have a first value or a second value. When it is determined that the sparsity data have the first value, the second computing core outputs the result value of the floating point calculation as output data. When it is determined that the sparsity data have the second value, the second computing core skips the floating point calculation and outputs the given value as the output data.

In an exemplary embodiment, the computing device further includes a first memory device that stores the first data, a second memory device that stores the second data, and a third memory device that stores the output data.

An operating method of a computing device according to an embodiment of the inventive concept includes receiving first data including a first sign bit, first exponent bits, and first fraction bits and second data including a second sign bit, second exponent bits, and second fraction bits, generating sparsity data based on the first sign bit, the first exponent bits, the second sign bit, and the second exponent bits, and, based on the sparsity data, generating a result value of a floating point calculation of the first data and the second data as output data or skipping the floating point calculation and outputting the output data having a given value.

In an exemplary embodiment, the generating of the sparsity data includes generating the sparsity data based on the first sign bit, the first exponent bits, the second sign bit, and the second exponent bits, when the floating point calculation is determined as forward propagation.

In an exemplary embodiment, the generating of the sparsity data includes performing an exclusive OR logic operation of the first sign bit and the second sign bit and an addition of the first exponent bits and the second exponent bits, performing linear encoding based on a value of the exclusive OR logic operation and a value of the addition to acquire a partial operation value, performing an accumulation operation based on the partial operation value and at least one previous partial operation value to acquire an integrated operation value, and generating the sparsity data based on a result of comparing the integrated operation value and a threshold value.

In an exemplary embodiment, the generating of the sparsity data based on the result of comparing the integrated operation value and the threshold value includes generating the sparsity data having a first value when the integrated operation value exceeds the threshold value, and generating the sparsity data having a second value when the integrated operation value is equal to or less than the threshold value.

In an exemplary embodiment, the generating of the result value of the floating point calculation of the first data and the second data as the output data or the skipping of the floating point calculation and the outputting of the output data having the given value, based on the sparsity data, includes determining whether the sparsity data have the first value or the second value, and performing the floating point calculation of the first data and the second data and generating the result value of the floating point calculation as the output data, when it is determined that the sparsity data have the first value.

In an exemplary embodiment, the generating of the result value of the floating point calculation of the first data and the second data as the output data or the skipping of the floating point calculation and the outputting of the output data having the given value, based on the sparsity data, includes determining whether the sparsity data have the first value or the second value, and generating the output data having the given value, when it is determined that the sparsity data have the second value.

### BRIEF DESCRIPTION OF THE FIGURES

The above and other objects and features of the inventive concept will become apparent by describing in detail exemplary embodiments thereof with reference to the accompanying drawings.

FIG. 1 is a block diagram illustrating a computing device.

FIG. 2 is a diagram describing an example of a floating point operation of FIG. 1.

FIG. 3 is a block diagram illustrating a computing device according to an embodiment of the inventive concept.

FIG. 4A is a diagram describing an example of a calculating process of a first computing device of FIG. 3.

FIG. 4B is a diagram describing an example of a calculating process of a second computing core of FIG. 3.

FIG. 5 is a block diagram illustrating a first computing core of FIG. 3 in detail.

FIG. 6 is a block diagram illustrating a computing device according to another embodiment of the inventive concept.

FIG. 7 is a diagram describing a deep neural network operation according to an embodiment of the inventive concept.

FIG. 8 is a flowchart illustrating an operating method of a computing device according to an embodiment of the inventive concept.

FIG. 9 is a flowchart illustrating a sparsity data calculating operation of FIG. 8 in detail.

### DETAILED DESCRIPTION

Below, embodiments of the inventive concept may be described in detail and clearly to such an extent that an ordinary one in the art easily implements the inventive concept. Below, for convenience of description, similar components are expressed by using the same or similar reference numerals.

In the following drawings or in the detailed description, modules may be connected with any other components except for components illustrated in a drawing or described in the detailed description. Modules or components may be connected directly or indirectly. Modules or components may be connected through communication or may be physically connected.

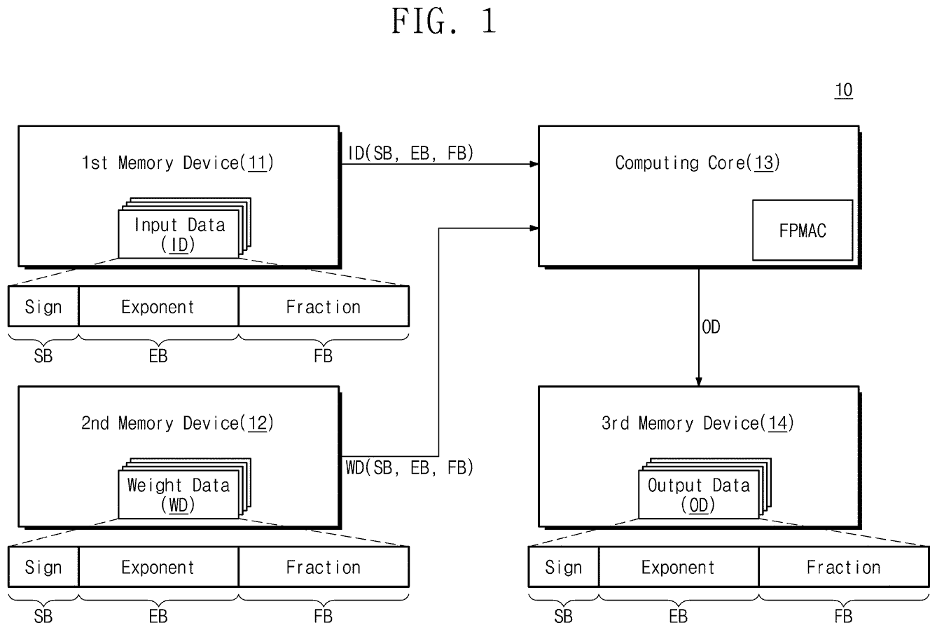

FIG. 1 is a block diagram illustrating a computing device 10 of FIG. 1. Referring to FIG. 1, the computing device 10 may include a first memory device 11, a second memory device 12, a computing core 13, and a third memory device 14. The computing device 10 may be a computing device that is based on a deep neural network (DNN). For example, the computing device 10 may be a device that generates output data OD having a value acquired by performing a convolution operation based on input data ID and weight data WD expressed by a floating point. A technique of the floating point means a way to express a real number with an approximate value at a computer with a point not fixed.

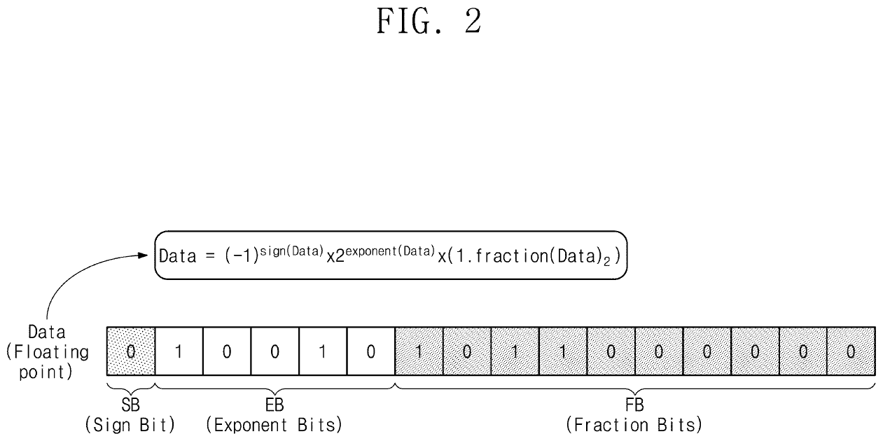

The first memory device 11 may store at least one input data ID. The input data ID may be a pixel value included in a captured image or may be a pixel value included in a recorded video. The at least one input data ID may be in the form of a floating point. The input data ID may include a sign bit SB, exponent bits EB, and fraction bits FB. The sign bit SB, the exponent bits EB, and the fraction bits FB will be more fully described with reference to FIG. 2.

The second memory device 12 may store at least one weight data WD. The weight data WD may be data corresponding to a feature to be extracted from the input data ID. The weight data WD are called a “weight parameter”, and a set of weight data WD are called a “filter” or a “kernel”. The at least one weight data WD may correspond to a numerical value expressed by a floating point. The weight data WD may include a sign bit SB, exponent bits EB, and fraction bits FB.

The computing core 13 may receive at least one input data ID from the first memory device 11. The computing core 13 may receive at least one weight data WD from the second memory device 12. The computing core 13 may perform a deep neural network (e.g., convolution) operation based on the at least one input data ID and the at least one weight data WD. The computing core 13 may output the output data OD having a value acquired based on the deep neural network operation to the third memory device 14.

In an exemplary embodiment, the computing core 13 may include a floating point multiply-accumulate (FPMAC) unit. The FPMAC unit may be a unit that performs a multiply-accumulate operation based on at least one input data ID and at least one weight data WD expressed by a floating point scheme. As the FPMAC unit performs operations on all signs, exponent, and factions of the input data ID and the weight data WD, a processing speed may be slow, and power consumption may be great.

The third memory device 14 may store at least one output data OD from the computing core 13. The output data OD may be data indicating at least a portion of a feature map. At least one output data OD may have a value that is generated by performing a convolution operation on at least one input data ID and at least one weight data WD. The output data OD may include a sign bit SB, exponent bits EB, and fraction bits FB.

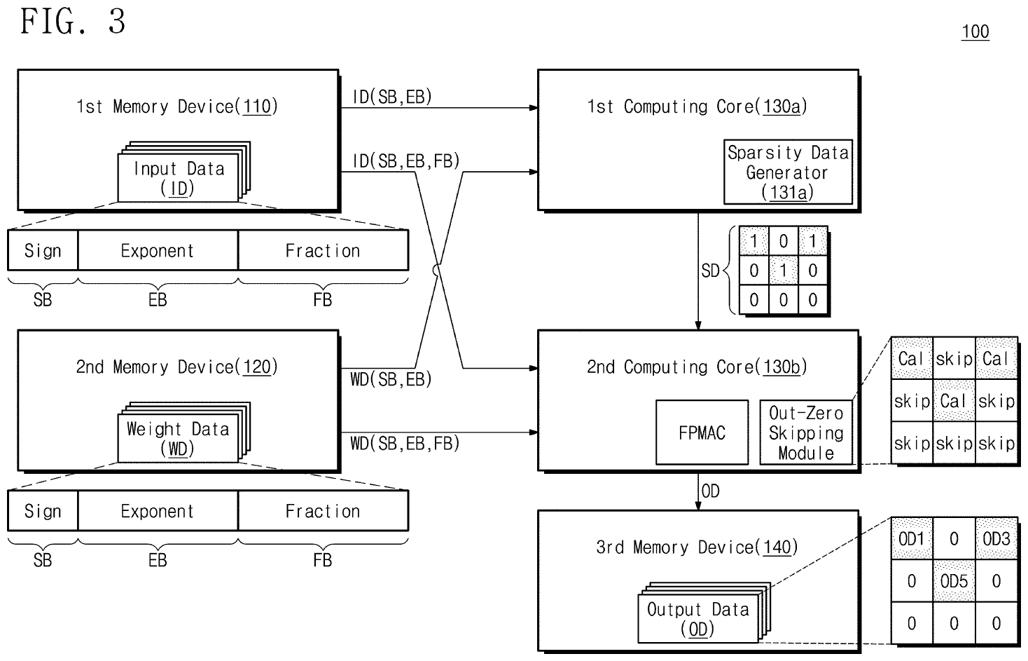

The computing device 10 that performs the convolution operation on the input data ID and the weight data WD may be higher than a conventional computing device (e.g., a computing device performing a simple comparison operation not a deep neural network operation) in recognition and accuracy of image processing. However, because the computing device 10 performs a lot of operations for inference and learning, the computing device 10 has the following issues: a long time necessary for calculation, a delay of a speed at which an image is processed, and an increase in power consumption. A computing device according to an embodiment of the inventive concept, which is implemented to solve the above issues, will be described with reference to FIG. 3.

FIG. 2 is a diagram describing an example of a floating point operation of FIG. 1. Data expressed by a floating point scheme is illustrated in FIG. 2. The data may correspond to the input data ID, the weight data WD, or the output data OD of FIG. 1. In the floating point scheme, the data may be expressed by Equation 1 below.

Data=(−1)^{sign(Data)}×2^{exponent(Data)}×(1·fraction(Data)₂) [Equation 1]

Equation 1 above is an equation describing data expressed by the floating point scheme. “Data” of the Equation 1 means data to be expressed in the floating point scheme. “Sign” is a function of outputting “0” when a sign is positive and outputting “1” when a sign is negative. “Exponent” of the Equation 1 is a function of extracting an exponent of a value normalized by a binary system. “Fraction” of the Equation 1 is a function of extracting a fraction of a value normalized by a binary system. In the Equation 1 above, “Sign(Data)” may correspond to the sign bit SB of data. “Exponent(Data)” may correspond to the exponent bits EB of data. “Fraction(Data)” may correspond to the fraction bits FB of data.

In detail, data may include a sign bit SB, exponent bits EB, and fraction bits FB. The sign bit SB may indicate “0” when a sign of data is positive and may indicate “1” when a sign of data is negative. The exponent bits EB may be bits corresponding to an exponent of data. The fraction bits FB may be bits corresponding to a fraction of data.

For example, assuming that data are expressed by a 16-bit floating point scheme according to the IEEE (Institute of Electrical and Electronic Engineers) 754 standard, a real number of 13.5₍₁₀₎ expressed in a decimal number system may be normalized to 1.1011₍₂₎*2³ in a decimal number system. In this case, because a sign is positive, the sign bit SB may indicate “0”. Because an exponent is “3” and an exponent bias value in a floating point scheme is “15”, the exponent bits EB may be “10010” corresponding to a binary number of a sum (18) of an exponent and an exponent bias value. Because a fraction is “1011”, the fraction bits FB may be “1011000000” acquired by filling “0” in bits after an effective fraction.

However, the inventive concept is not limited thereto. The computing device 10 according to an embodiment of the inventive concept may be applied to all floating point calculations expressed by a combination of a sign, an exponent, and a fraction, as well as the floating point calculation of the IEEE standard.

For brevity of illustration and convenience of description, an example is illustrated in FIG. 2 as data are expressed by a 16-bit floating point, but the inventive concept is not limited thereto. For example, data may be expressed by an n-bit floating point. Herein, “n” is any natural number.

For example, in the case where data are expressed by a 16-bit floating point, the sign bit SB of the data may be formed of one bit, the exponent bits EB of the data may be formed of 5 bits, and the fraction bits FB of the data may be formed of 10 bits.

For example, in the case where data are expressed by a 32-bit floating point, the sign bit SB of the data may be formed of one bit, the exponent bits EB of the data may be formed of 8 bits, and the fraction bits FB of the data may be formed of 23 bits.

For example, in the case where data are expressed by a 64-bit floating point, the sign bit SB of the data may be formed of one bit, the exponent bits EB of the data may be formed of 11 bits, and the fraction bits FB of the data may be formed of 52 bits.

As the number of bits constituting the exponent bits EB of data increases, a great number and a small number may be expressed. As the number of bits constituting the fraction bits FB of data increases, an approximate value may be expressed closer to an actual value. Meanwhile, as the number of bits constituting the exponent bits EB and the number of bits constituting the fraction bits FB increase, the size (or capacity) of data (or the number of bits of data) may increase, and necessary throughput may increase.

FIG. 3 is a block diagram illustrating the computing device 100 according to an embodiment of the inventive concept. Referring to FIG. 3, the computing device 100 may include a first memory device 110, a second memory device 120, a first computing core 130a, a second computing core 130b, a third memory device 140. The first memory device 110, the second memory device 120, and the third memory device 140 are similar to the first memory device 11, the second memory device 12, and the third memory device 14 of FIG. 1, and thus, additional description will be omitted to avoid redundancy.

The first computing core 130a may receive at least one input data ID from the first memory device 110. The first computing core 130a may receive at least one weight data WD from the second memory device 120. The first computing core 130a may include a sparsity data generator 131a. The sparsity data generator 131a may generate sparsity data SD based on the sign bit SB and the exponent bits EB of the input data ID and the sign bit SB and the exponent bits EB of the weight data WD. The first computing core 130a may output the sparsity data SD to the second computing core 130b. Because a calculation using the sparsity data SD is performed only by using a sign and an exponent without a fraction, the calculation using the sparsity data SD may be faster than a general fraction calculation.

The sparsity data SD may be data that are acquired by predicting whether the corresponding output data OD are necessary for a deep neural network operation, before the main calculation (e.g., a floating point calculation of the second computing core 130b) is performed. For example, the output data OD having a negative value and the output data OD having a value of “0” may be data unnecessary in a feature map. The sparsity data SD may be a bit flag that is determined only by using the sign bit SB and the exponent bits EB without computing the fraction bits FB in the following manner: marked by “1” when the corresponding output data OD is predicted as having a positive value and marked by “0” when the corresponding output data OD is predicted as a negative value or “0”. In this case, prediction may mean to perform calculation only by using a sign and an exponent among a sign, an exponent, and a fraction of a floating point system.

For example, in the case where the sparsity data SD associated with the input data ID and the weight data WD are “0”, a convolution operation (e.g., a floating point calculation using a sign, an exponent, and a fraction) of the input data ID and the weight data WD may be omitted, and the output data OD having a given value (e.g., “0”) may be generated. In contrast, in the case where the sparsity data SD associated with the input data ID and the weight data WD are “1”, the convolution operation of the input data ID and the weight data WD may be performed, and the output data OD having a value of the convolution operation may be generated.

In an exemplary embodiment, when a predicted value of the output data OD is equal to or less than a threshold value, the first computing core 130a may determine the output data OD as a specific value (e.g., “0”). The threshold value may be a small value that is determined in advance as a reference for determining output data as a specific value (e.g., “0”). For example, when a value calculated based on the exponent bits EB of the input data ID and the exponent bits EB of the weight data WD is smaller than the threshold value, the first computing core 130a may predict that the corresponding output data OD are “0”.

The second computing core 130b may receive at least one input data ID from the first memory device 110. The second computing core 130b may receive at least one weight data WD from the second memory device 120. The second computing core 130b may receive the sparsity data SD from the first computing core 130a. The second computing core 130b may omit a floating point calculation corresponding to the sparsity data SD marked by “0” and may generate the output data OD having a given value (e.g., “0”). The second computing core 130b may perform a floating point calculation corresponding to the sparsity data SD marked by “1” and may generate the output data OD. The second computing core 130b may output output data OD to the third memory device 140.

The second computing core 130b may include an FPMAC unit and an out-zero skipping module. The out-zero skipping module may determine whether the sparsity data SD have a first value (e.g., “1”) or a second value (e.g., “0”), and may control the FPMAC unit to perform a floating point calculation of the input data ID and the weight data WD based on the determination of the sparsity data SD. Also, when it is determined that the sparsity data SD have the second value (e.g., “0”), the out-zero skipping module may generate the output data OD having a given value (e.g., “0”).

Under the control of the out-zero skipping module, the FPMAC unit may perform the floating point calculation corresponding to the sparsity data SD determined as having the first value (e.g., “1”). The FPMAC unit may generate the output data OD having a value that is acquired based on the floating point calculation.

For example, at least a portion of at least one output data OD forms a 3×3 matrix and first, third, and fifth output data OD1, OD3, and OD5 are predicted by the first computing core 130a as positive numbers, the second computing core 130b may generate the first, third, and fifth output data OD1, OD3, and OD5 having values acquired by performing the floating point calculation. The second computing core 130b may generate any other output data other than the first, third, and fifth output data OD1, OD3, and OD5, without the floating point calculation. The other output data may have a given value (e.g., “0”).

As described above, according to an embodiment of the inventive concept, as the sparsity data SD are generated based on a sign and an exponent among a sign, an exponent, and a fraction of floating-point data, and an unnecessary convolution operation is omitted based on the sparsity data SD, the computing device 100 may be provided, which may have the reduction of a time necessary for calculation, an increase in a speed at which an image is processed, and a decrease in power consumption.

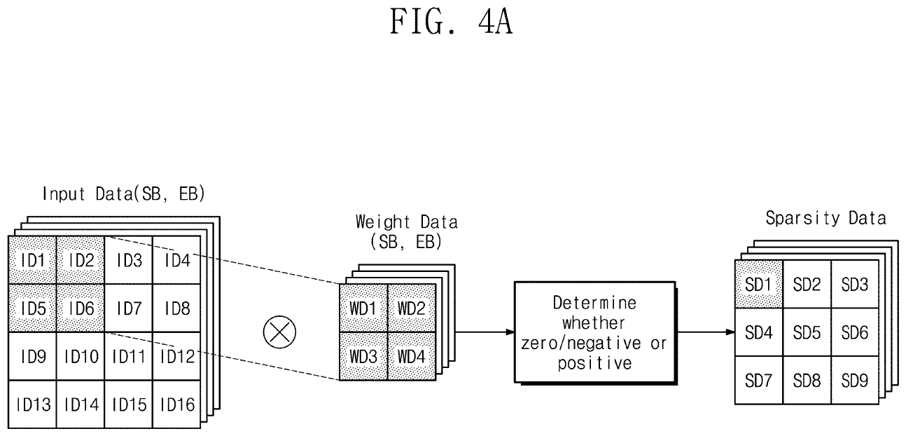

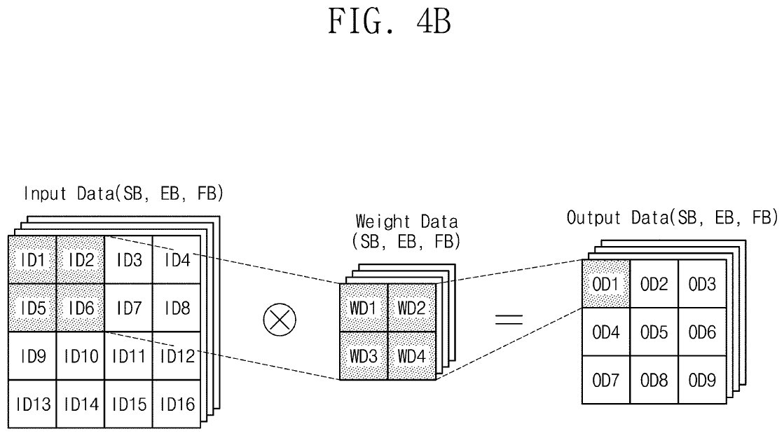

FIG. 4A is a diagram describing an example of a calculating process of the first computing core 130a of FIG. 3. A process in which the first computing core 130a generates the sparsity data SD based on the input data ID and the weight data WD will be described with reference to FIGS. 3 and 4A. The first computing core 130a may generate the sparsity data SD based on the sign bit SB and the exponent bits EB of the input data ID and the sign bit SB and the exponent bits EB of the weight data WD.

A set of input data ID stored in the first memory device 110 may form an input data matrix. For example, the input data matrix may correspond to an image file. For better understanding, an example is illustrated as the input data matrix has a 4×4 size and includes first to sixteenth input data ID1 to ID16. However, the inventive concept is not limited thereto. For example, the number of rows of the input data matrix may increase or decrease, and the number of columns of the input data matrix may increase or decrease.

A set of weight data WD stored in the second memory device 120 may form a weight data matrix. For example, the weight data matrix may correspond to a set of weight data, a filter, or a kernel. For better understanding, an example is illustrated as the weight data matrix has a 2×2 size and includes first to fourth weight data WD1 to WD4. The size of the weight data matrix may be smaller than the size of the input data matrix. However, the inventive concept is not limited thereto. For example, the number of rows of the weight data matrix may increase or decrease, and the number of columns of the weight data matrix may increase or decrease.

In an exemplary embodiment, the first computing core 130a may generate sparsity data based on at least a portion of the input data matrix and the weight data matrix. For example, the first computing core 130a may generate first sparsity data SD1 based on the input data ID1, ID2, ID5, and ID6 of the input data matrix and weight data WD1, WD2, WD3, and WD4 of the weight data matrix.

In detail, when a value predicted based on the sign bit SB and the exponent bits EB of the respective input data ID1, ID2, ID5, and ID6 and the sign bit SB and the exponent bits EB of the respective weight data WD1, WD2, WD3, and WD4 exceeds the threshold value, a value of the first sparsity data SD1 may be determined as a first value (e.g., “1”). In detail, when the value predicted based on the sign bit SB and the exponent bits EB of the respective input data ID1, ID2, ID5, and ID6 and the sign bit SB and the exponent bits EB of the respective weight data WD1, WD2, WD3, and WD4 is equal to or less than the threshold value (also, when a magnitude of the predicted value exceeds the threshold value (TV) but the predicted value is negative), a value of the first sparsity data SD1 may be determined as a second value (e.g., “0”).

As in the first sparsity data SD1, second to ninth sparsity data SD2 to SD9 may be generated. For example, the first computing core 130a may generate the second sparsity data SD2 based on the input data ID2, ID3, ID6, and ID7 of the input data matrix and weight data WD1, WD2, WD3, and WD4 of the weight data matrix. The first computing core 130a may generate the third sparsity data SD3 based on the input data ID3, ID4, ID7, and ID8 of the input data matrix and weight data WD1, WD2, WD3, and WD4 of the weight data matrix. The plurality of sparsity data SD1 to SD9 thus generated may form a sparsity data matrix.

FIG. 4B is a diagram describing an example of a calculating process of the second computing core 130b of FIG. 3. A process in which the second computing core 130b generates the output data OD based on the input data ID, the weight data WD, and the sparsity data SD will be described with reference to FIGS. 3 and 4B. The second computing core 130b may generate the output data OD based on the input data ID, the weight data WD, and the sparsity data SD.

In this case, when the output data OD correspond to the sparsity data SD having a first value (e.g., “1”), the second computing core 130b may generate the output data OD having a value acquired based on the floating point calculation of the input data ID and the weight data WD. In contrast, when the output data OD correspond to the sparsity data SD having a second value (e.g., “0”), the second computing core 130b may generate the output data OD having a given value without the floating point calculation.

A set of input data ID stored in the first memory device 110 may form an input data matrix. A set of weight data WD stored in the second memory device 120 may form a weight data matrix. Characteristics of the input data matrix and the weight data matrix are similar to those described with reference to FIG. 4A, and thus, additional description will be omitted to avoid redundancy.

A set of output data OD generated by the second computing core 130b may form an output data matrix. The third memory device 140 may receive and store the output data matrix from the second computing core 130b. For example, the output data matrix may correspond to a feature map.

A size of the output data matrix may be determined based on the size of the input data matrix and the size of the weight data matrix. The size of the output data matrix may be equal to the size of the sparsity data matrix of FIG. 4A. For better understanding, an example is illustrated as the output data matrix has a 3×3 size and includes first to fourth output data OD1 to OD9. However, the inventive concept is not limited thereto. For example, the number of rows of the output data matrix may increase or decrease, and the number of columns of the output data matrix may increase or decrease.

In an exemplary embodiment, the second computing core 130b may generate output data based on at least a portion of the input data matrix, the weight data matrix, and the corresponding sparsity data. For example, the second computing core 130b may generate the first output data OD1 based on the input data ID1, ID2, ID5, and ID6 of the input data matrix, the weight data WD1, WD2, WD3, and WD4 of the weight data matrix, and the first sparsity data SD1.

In detail, when the first sparsity data SD1 has a first value (e.g., “1”), the second computing core 130b may generate the first output data OD1 having a value acquired based on the floating point calculation of the input data ID1, ID2, ID5, and ID6 and the weight data WD1, WD2, WD3, and WD4. A value of the first output data OD1 may be acquired through the following: ID1*WD1+ID2*WD2+ID5*WD3+ID6*WD4. When the first sparsity data SD1 has a second value (e.g., “0”), the second computing core 130b may generate the first output data OD1 having a given value (e.g., “0”) without performing the floating point calculation. As in the first output data OD1, second to ninth output data OD2 to OD9 may be generated.

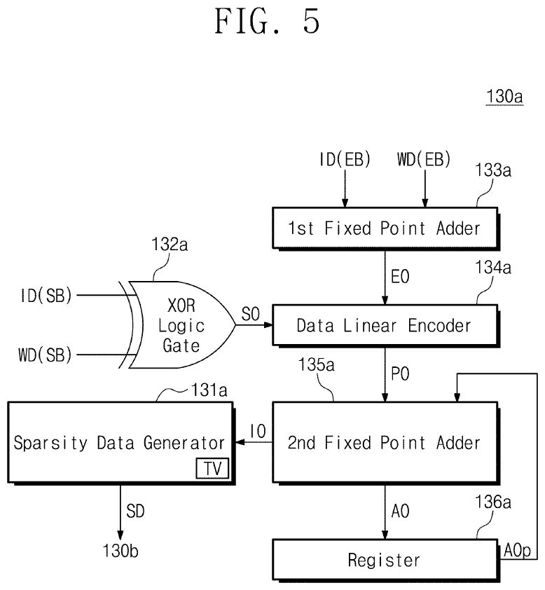

FIG. 5 is a block diagram illustrating the first computing core 130a of FIG. 3 in detail. The first computing core 130a that generates the sparsity data SD based on the sign bit SB and the exponent bits EB is illustrated in FIG. 5. The first computing core 130a may include the sparsity data generator 131a, an XOR logic gate 132a, a first fixed point adder 133a, a data linear encoder 134a, a second fixed point adder 135a, and a register 136a.

The XOR logic gate 132a may receive the sign bit SB of the input data ID and the sign bit SB of the weight data WD. The XOR logic gate 132a may generate a sign operation signal SO based on an XOR logic operation of the sign bit SB of the input data ID and the sign bit SB of the weight data WD.

The first fixed point adder 133a may receive the exponent bits EB of the input data ID and the exponent bits EB of the weight data WD. The first fixed point adder 133a may generate an exponent operation signal EO based on an addition of the exponent bits EB of the input data ID and the exponent bits EB of the weight data WD.

The data linear encoder 134a may receive the sign operation signal SO from the XOR logic gate 132a. The data linear encoder 134a may receive the exponent operation signal EO from the first fixed point adder 133a. The data linear encoder 134a may generate a partial operation signal PO based on the sign operation signal SO and the exponent operation signal EO. The partial operation signal PO may include a value acquired by linearly encoding a calculation value of a sign and a calculation value of an exponent. In an exemplary embodiment, the data linear encoder 134a may be an encode performing one-hot encoding.

The second fixed point adder 135a may receive the partial operation signal PO from the data linear encoder 134a. The second fixed point adder 135a may receive a previous accumulation operation signal AOp corresponding to at least one previous partial operation signal (not illustrated) from the register 136a. The second fixed point adder 135a may generate an integrated operation signal IO or an accumulation operation signal AO, based on the previous accumulation operation signal AOp from the register 136a and the partial operation signal PO.

The integrated operation signal IO may be a signal corresponding to all pieces of corresponding input data and all pieces of weight data. The accumulation operation signal AO may be a signal corresponding to a part of pieces of corresponding input data and a part of pieces of weight data. For example, in FIG. 4A, in the case of generating the first sparsity data SD1, the integrated operation signal IO may correspond to a value computed based on the input data ID1, ID2, ID5, and ID6 and the weight data WD1, WD2, WD3, and WD4, and the accumulation operation signal AO may correspond to a value computed based on the input data ID1, ID2, and ID5 and the weight data WD1, WD2, and WD3.

The register 136a may output the previous accumulation operation signal AOp to the second fixed point adder 135a. The register 136a may receive the accumulation operation signal AO from the second fixed point adder 135a. The register 136a may store a value corresponding to the accumulation operation signal AO. Before the calculation of next input data ID and next weight data WD corresponding to one sparsity data SD is performed, the register 136a may treat the accumulation operation signal AO as the previous accumulation operation signal AOp. As the calculation of all input data ID and all weight data WD corresponding to one sparsity data SD is performed, a value corresponding to the accumulation operation signal AO stored in the register 136a may be reset.

The sparsity data generator 131a may receive the integrated operation signal IO from the second fixed point adder 135a. The sparsity data generator 131a may store the threshold value TV. When a value corresponding to the integrated operation signal IO exceeds the threshold value TV, the sparsity data generator 131a may generate the sparsity data SD having a first value (e.g., “1”). When the value corresponding to the integrated operation signal IO is equal to or less than the threshold value TV (also, when the value corresponding to the integrated operation signal IO exceeds the threshold value TV but a value corresponding to the integrated operation signal IO is negative), the sparsity data generator 131a may generate the sparsity data SD having a second value (e.g., “0”). The sparsity data generator 131a may output the sparsity data SD to the second computing core 130b.

A characteristic in which the first computing core 130a performs calculation based on a plurality of input data ID and a plurality of weight data WD corresponding to one sparsity data SD will be more fully described with reference to Equation 2 below.

$$\begin{matrix}\sum ( WD \times ID ) = \sum ( {( - 1 )}^{sign ( WD )} \times {2}^{exponent ( WD )} \times \\ {( - 1 )}^{sign ( ID )} \times {2}^{exponent ( ID )} \\ = \sum ( {( - 1 )}^{XOR ( sign ( WD ) sign ( ID ) )} \times \\ {2}^{exponent ( WD ) + exponent ( ID )}\end{matrix} \qquad [ Equation 2 ]$$

Equation 2 is an equation describing a process in which the first computing core 130a computes the sparsity data SD. “WD” is weight data. “ID” is input data. “Σ” means to add a plurality of input data and a plurality of weight data corresponding to one sparsity data SD. A sign may be computed based on an XOR logic operation. An exponent may be computed based on an addition operation.

In detail, the XOR logic operation of the sign may be performed by the XOR logic gate 132a. The addition operation of the exponent may be performed by the first fixed point adder 133a. Calculation for transformation to a 2′ or −2″ form based on the computed sign and the computed exponent may be performed by the data linear encoder 134a. The addition operation corresponding to “Σ” may be performed by the second fixed point adder 135a. The register 136a may function as a buffer assisting the addition of the second fixed point adder 135a.

In an exemplary embodiment, the first computing core 130a may be configured to calculate at least one sign value based on a first sign bit and a second sign bit, to calculate at least one exponent value based on first exponent bits and second exponent bits, to calculate at least one partial sum based on the at least one sign value and the at least one exponent value, to generate the sparsity data SD having a first value when a value of accumulating the at least one partial sum exceeds the threshold value TV, and to generate the sparsity data SD having a second value when the value of accumulating the at least one partial sum is equal to or less than the threshold value TV.

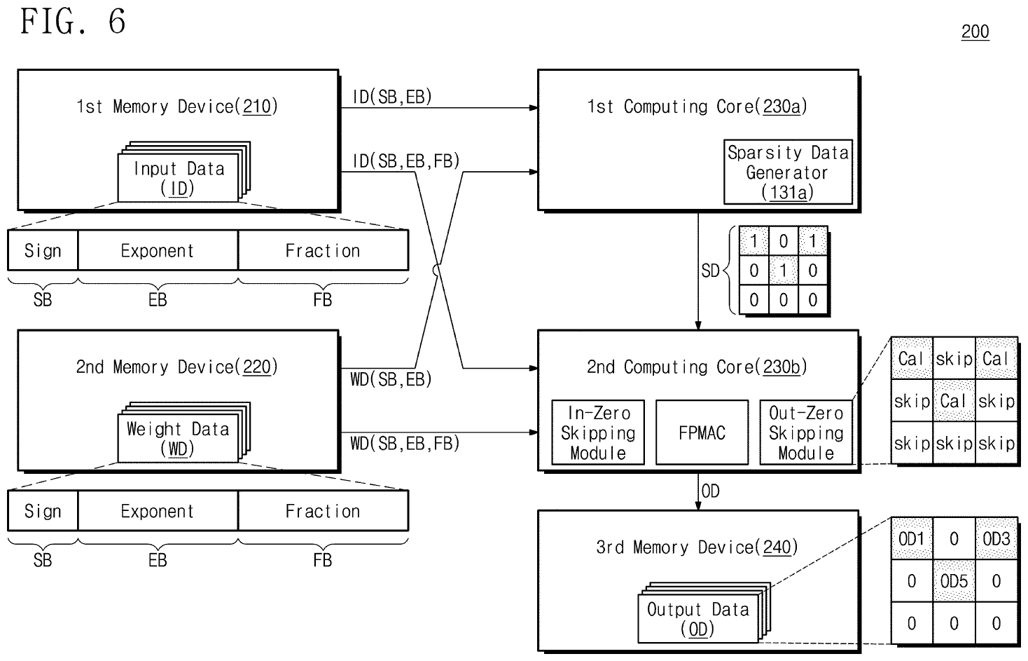

FIG. 6 is a block diagram illustrating a computing device 200 according to another embodiment of the inventive concept. Referring to FIG. 3, the computing device 200 may include a first memory device 110, a second memory device 120, a first computing core 130a, a second computing core 130b, a third memory device 140. The first memory device 110, the second memory device 120, the first computing core 130a, and the third memory device 140 are similar to the first memory device 110, the second memory device 120, the first computing core 130a, and the third memory device 140 of FIG. 3, and thus, additional description will be omitted to avoid redundancy.

The second computing core 130b may include an FPMAC unit, an in-zero skipping module, and the out-zero skipping module. That is, unlike the second computing core 130b of FIG. 3, the second computing core 130b may further include the in-zero skipping module.

The in-zero skipping module may determine whether the input data ID or the weight data WD have a specific value (e.g., “0”), and may control the FPMAC unit to perform the floating point calculation of the input data ID and the weight data WD based on the determination of the input data ID or the weight data WD. When it is determined that the input data ID or the weight data WD have the specific value (e.g., “0”), the in-zero skipping module may generate the output data OD having a given value (e.g., “0”).

As the out-zero skipping module determines whether to skip the floating point calculation based on the sparsity data SD being a result of predicting the output data OD, while the in-zero skipping module determines whether to skip the floating point calculation based on the input data ID or the weight data WD itself, the in-zero skipping module may be different from the out-zero skipping module.

In an exemplary embodiment, the in-zero skipping module may generate the output data OD based on the exponent bits EB of the input data ID or the exponent bits EB of the weight data WD. For example, when a value of the exponent bits EB of the input data ID or a value of the exponent bits EB of the weight data WD is equal to or less than the threshold value, the in-zero skipping module may generate the output data OD having a given value (e.g., “0”). In this case, the floating point calculation corresponding to the output data OD may be skipped.

As described above, according to an embodiment of the inventive concept, as the out-zero skipping module skips an unnecessary convolution operation based on the sparsity data SD and the in-zero skipping module skips an unnecessary convolution operation based on a result of determining whether the input data ID or the weight data WD have a specific value, the computing device 200 may provide the following: the reduction of a time necessary for calculation, an increase in a speed at which an image is processed, and a decrease in power consumption.

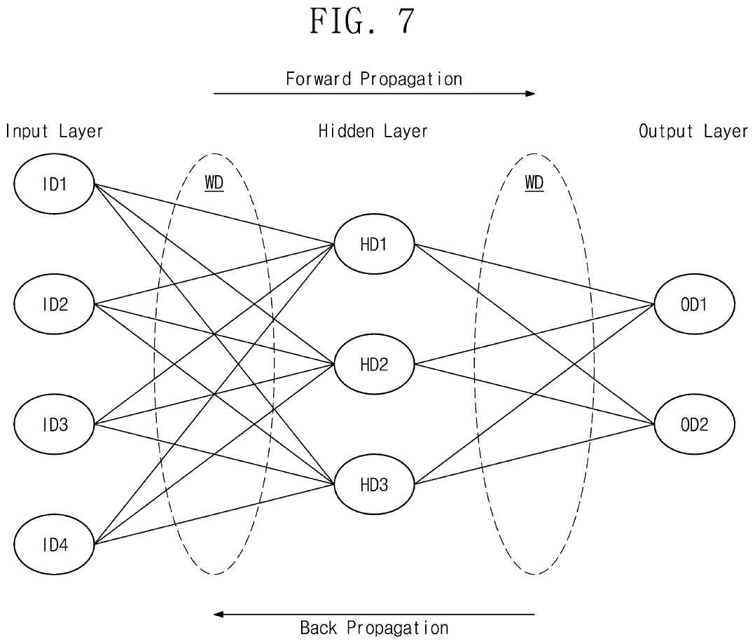

FIG. 7 is a diagram describing a deep neural network operation according to an embodiment of the inventive concept. A deep neural network operation will be described with reference to FIG. 7. In the deep neural network operation, forward propagation and back propagation may be performed to perform inference and learning. The forward propagation may mean processing data toward an output layer from an input layer. The back propagation may mean processing data toward the input layer from the output layer.

The processing of pieces of data in the deep neural network operation will be described with reference to the input layer, a hidden layer, and the output layer. The input layer may include a plurality of input data ID1 to ID4. The hidden layer may include a plurality of hidden data HD1 to HD3. The output layer may include a plurality of output data OD1 to OD2. The calculation between layers (e.g., the calculation between the input layer and the hidden layer or the calculation between the hidden layer and the output layer) may be performed based on a convolution operation of pieces of data of a previous layer and the weight data WD.

The number of data included in each of the input layer, the hidden layer, and the output layer is exemplary, and the number of data may increase or decrease. Also, depending on a deep neural network operation to be performed, the number of hidden layers between the input layer and the output layer may increase, or the hidden layer may be omitted.

In an exemplary embodiment, a convolution operation, the result of which is predicted as a specific value (e.g., “0”), from convolution operations between layers may be omitted. For example, the computing device 100 of FIG. 3 may generate the sparsity data SD based on the plurality of input data ID1 to ID4 of the input layer and the corresponding weight data WD, may skip an unnecessary calculation (e.g., a calculation result being negative or “0”) based on the sparsity data SD, and may generate the hidden data HD1 to HD3.

For another example, the computing device 100 of FIG. 3 may generate the sparsity data SD based on the hidden data HD1 to HD3 of the hidden layer and the corresponding weight data WD, may skip an unnecessary calculation based on the sparsity data SD, and may generate the output data OD1 and OD2.

In an exemplary embodiment, a computing device may generate sparsity data in a forward propagation calculation to skip an unnecessary calculation. In detail, a back propagation calculation may be performed after the forward propagation calculation. Sparsity data in the back propagation calculation may be identical to the sparsity data in the corresponding forward propagation calculation. The back propagation calculation may refer to the forward propagation calculation. However, because the forward propagation calculation fails to refer to the back propagation calculation to be performed later on the basis of time, the practical benefit of generating sparsity data in the forward propagation calculation may be great. For example, the computing device 100 of FIG. 3 may generate the sparsity data SD in the forward propagation calculation to skip an unnecessary calculation, and the computing device 100 may skip an unnecessary calculation with reference to the sparsity data of the forward propagation calculation in the back propagation calculation.

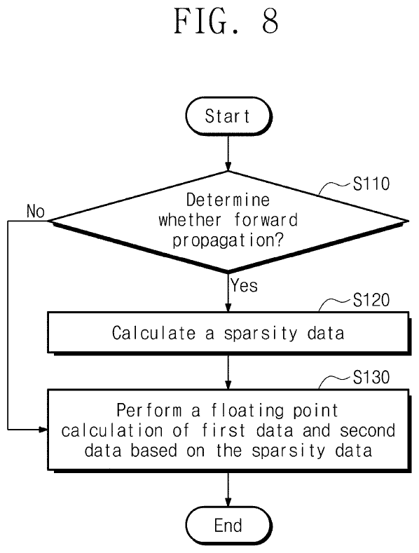

FIG. 8 is a flowchart illustrating an operating method of a computing device according to an embodiment of the inventive concept. The operating method of the computing device will be described with reference to FIG. 8. In operation S110, the computing device may determine whether a floating point calculation of input data and weight data corresponds to forward propagation. When it is determined that the floating point calculation corresponds to the forward propagation, the computing device may perform operation S120. When it is determined that the floating point calculation does not correspond to the forward propagation (e.g., when it is determined that the floating point calculation corresponds to back propagation), the computing device may perform operation S130.

In operation S120, the computing device may generate sparsity data. In detail, the computing device may generate the sparsity data based on a sign bit and exponent bits of the input data and a sign bit and exponent bits of the weight data. When a result of the floating point calculation of the input data and the weight data is positive, the sparsity data may have a first value. When the result of the floating point calculation of the input data and the weight data is negative or has a specific value (e.g., “0”), the sparsity data may have a second value.

In operation S130, the computing device may perform the floating point calculation of the input data and the weight data based on the sparsity data. In detail, when it is determined that the sparsity data have the first value, the computing device may generate output data having a value acquired based on the floating point calculation of the input data and the weight data. When it is determined that the sparsity data have the second value, the computing device may generate output data having a given value. Operation S130 may be performed when it is determined in operation S110 that the floating point calculation does not correspond to the forward propagation or may be performed after operation S120. When it is determined in operation S110 that the floating point calculation does not correspond to the forward propagation (e.g., when it is determined that the floating point calculation corresponds to the back propagation), the computing device may refer to the sparsity data of the forward propagation corresponding to the back propagation.

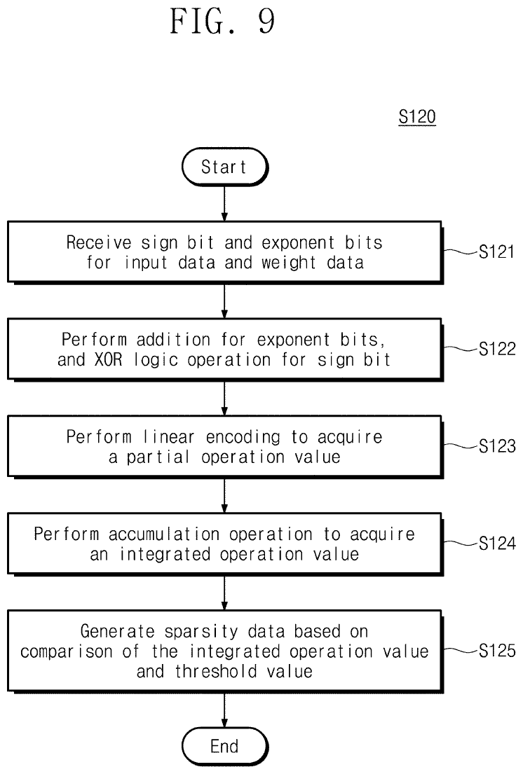

FIG. 9 is a flowchart illustrating operation S130 of calculating sparsity data of FIG. 8 in detail. A flowchart of operation S120 for sparsity data calculation according to the flowchart of FIG. 8 is in detail illustrated in FIG. 9. Operation S120 may include operation S121 to operation S125.

In operation S121, the computing device may receive a sign bit and exponent bits of input data and a sign bit and exponent bits of weight data, In an exemplary embodiment, the computing device may load the sign bit and the exponent bits of the input data from a first embedded memory device and may load the sign bit and the exponent bits of the weight data from a second embedded memory device.

In operation S122, the computing device may perform an exclusive OR logic operation on the sign bit of the input data and the sign bit of the weight data. The computing device may perform addition on the exponent bits of the input data and the exponent bits of the weight data.

In operation S123, the computing device may acquire a partial operation value by performing linear encoding based on a result of the exclusive OR logic operation performed in operation S122 and a result of the addition performed in operation S122.

In operation S124, the computing device may acquire an integrated operation value by performing an accumulation operation based on the partial operation value acquired in operation S123 and at least one previous partial operation value. For example, referring together to FIGS. 4A and 9, the partial operation value acquired in operation S123 may correspond to “ID6*WD4”, the at least one previous partial operation value may correspond to “ID1*WD1+ID2*WD2+ID5*WD3”, and the integrated operation value may correspond to “ID1*WD1+ID2*WD2+ID5*WD3+ID6*WD4”.

In operation S125, the computing device may generate sparsity data based on a result of comparing the integrated operation value acquired in operation S124 and the threshold value. When a comparison result indicates that the integrated operation value exceeds the threshold value, the sparsity data may have a first value. When the comparison result indicates that the integrated operation value is equal to or less than the threshold value (also, when the integrated operation value exceeds the threshold value but is negative), the sparsity data may have a second value.

According to an embodiment of the inventive concept, a computing device using sparsity data generated based on a simplified floating point calculation and an operating method thereof are provided.

Also, according to an embodiment of the inventive concept, as unnecessary calculations are skipped by using the sparsity data, a computing device in which a calculating speed increases and power consumption is reduced and an operating method thereof are provided.

While the inventive concept has been described with reference to exemplary embodiments thereof, it will be apparent to those of ordinary skill in the art that various changes and modifications may be made thereto without departing from the spirit and scope of the inventive concept as set forth in the following claims.

What is claimed is:

1. A computing device comprising:
a first computing core configured to generate sparsity data based on a first sign bit and first exponent bits of first data and a second sign bit and second exponent bits based on second data; and
a second computing core configured to output a result value of a floating point calculation of the first data and the second data as output data or configured to skip the floating point calculation and to output the output data having a given value, based on the sparsity data.

2. The computing device of claim 1, wherein the first data are included in an input layer of a deep neural network or are included in at least one hidden layer of the deep neural network.

3. The computing device of claim 1, wherein the floating point calculation is performed based on the first sign bit, the first exponent bits, and first fraction bits of the first data and the second sign bit, the second exponent bits, and second fraction bits of the second data.

4. The computing device of claim 1, further comprising:
a first memory device configured to store the first data;
a second memory device configured to store the second data; and
a third memory device configured to store the output data.

5. The computing device of claim 1, wherein the first computing core is further configured to:
calculate at least one sign value based on the first sign bit and the second sign bit;
calculate at least one exponent value based on the first exponent bits and the second exponent bits;
calculate at least one partial sum based on the at least one sign value and the at least one exponent value;
generate the sparsity data having a first value when a value of accumulating the at least one partial sum exceeds a threshold value; and
generate the sparsity data having a second value when the value of accumulating the at least one partial sum is equal to or less than the threshold value.

6. The computing device of claim 1, wherein the first computing core includes:
a logic gate configured to generate a sign operation signal based on an exclusive OR logic operation of the first sign bit and the second sign bit;
a first fixed point adder configured to generate an exponent operation signal based on an addition of the first exponent bits and the second exponent bits;
a data linear encoder configured to generate a partial operation signal based on the sign operation signal and the exponent operation signal;
a second fixed point adder configured to generate an integrated operation signal or an accumulation operation signal, based on a previous accumulation operation signal corresponding to at least one previous partial operation signal and the partial operation signal;
a register configured to provide the previous accumulation operation signal to the second fixed point adder and to store the accumulation operation signal; and
a sparsity data generator configured to generate the sparsity data having a first value when a value corresponding to the integrated operation signal exceeds a threshold value and to generate the sparsity data having a second value when the value corresponding to the integrated operation signal is equal to or less than the threshold value.

7. The computing device of claim 1, wherein the second computing core includes:
an out-zero skipping module configured to determine whether the sparsity data have a first value or a second value, to control whether to perform the floating point calculation, and to generate the output data having the given value when it is determined that the sparsity data have the second value; and
a floating point multiply-accumulate (FPMAC) unit configured to perform the floating point calculation under control of the out-zero skipping module and to generate the result value of the floating point calculation as the output data.

8. The computing device of claim 7, wherein the second computing core further includes:
an in-zero skipping module configured to generate the output data having the given value when a value of the first exponent bits or a value of the second exponent bits is equal to or less than a threshold value.

9. The computing device of claim 1, wherein the first data are input data expressed by a 16-bit floating point, a 32-bit floating point, or a 64-bit floating point complying with an IEEE (Institute of Electrical and Electronic Engineers) 754 standard, and
wherein the second data are weight data expressed by the 16-bit floating point, the 32-bit floating point, or the 64-bit floating point complying with the IEEE 754 standard.

10. A computing device comprising:
a first computing core configured to generate sparsity data based on first data and second data; and
a second computing core configured to output one of a result value of a floating point calculation of the first data and the second data and a given value as output data, based on the sparsity data.

11. The computing device of claim 10, wherein the sparsity data are generated based on a sign and an exponent of the first data and a sign and an exponent of the second data, and
wherein the floating point calculation is performed based on the sign, the exponent, and a fraction of the first data and the sign, the exponent bits, and a fraction of the second data.

12. The computing device of claim 10, wherein the second computing core is further configured to:
determine whether the sparsity data have a first value or a second value;
when it is determined that the sparsity data have the first value, output the result value of the floating point calculation as output data; and
when it is determined that the sparsity data have the second value, skip the floating point calculation and output the given value as the output data.

13. The computing device of claim 10, further comprising:
a first memory device configured to store the first data;
a second memory device configured to store the second data; and
a third memory device configured to store the output data.

14. An operating method of a computing device, the method comprising:
receiving first data including a first sign bit, first exponent bits, and first fraction bits and second data including a second sign bit, second exponent bits, and second fraction bits;
generating sparsity data based on the first sign bit, the first exponent bits, the second sign bit, and the second exponent bits; and
based on the sparsity data, generating a result value of a floating point calculation of the first data and the second data as output data or skipping the floating point calculation and outputting the output data having a given value.

15. The method of claim 14, wherein the generating of the sparsity data includes:
when the floating point calculation is determined as forward propagation, generating the sparsity data based on the first sign bit, the first exponent bits, the second sign bit, and the second exponent bits.

16. The method of claim 14, wherein the generating of the sparsity data includes:
performing an exclusive OR logic operation of the first sign bit and the second sign bit and an addition of the first exponent bits and the second exponent bits;
performing linear encoding based on a value of the exclusive OR logic operation and a value of the addition to acquire a partial operation value;
performing an accumulation operation based on the partial operation value and at least one previous partial operation value to acquire an integrated operation value; and
generating the sparsity data based on a result of comparing the integrated operation value and a threshold value.

17. The method of claim 16, wherein the generating of the sparsity data based on the result of comparing the integrated operation value and the threshold value includes:
generating the sparsity data having a first value when the integrated operation value exceeds the threshold value; and
generating the sparsity data having a second value when the integrated operation value is equal to or less than the threshold value.

18. The method of claim 17, wherein the generating of the result value of the floating point calculation of the first data and the second data as the output data or the skipping of the floating point calculation and the outputting of the output data having the given value, based on the sparsity data, includes:
determining whether the sparsity data have the first value or the second value; and
when it is determined that the sparsity data have the first value, performing the floating point calculation of the first data and the second data and generating the result value of the floating point calculation as the output data.

19. The method of claim 17, wherein the generating of the result value of the floating point calculation of the first data and the second data as the output data or the skipping of the floating point calculation and the outputting of the output data having the given value, based on the sparsity data, includes:
determining whether the sparsity data have the first value or the second value; and
when it is determined that the sparsity data have the second value, generating the output data having the given value.
